(19) United States
(12) Patent Application Publication
(10) Pub. No.: US 2022/0032196 A1
(43) Pub. Date: Feb. 3, 2022

(54) ANIMATION PRODUCTION SYSTEM

(71) Applicant: AniCast RM Inc., Minato-ku (JP)

(72) Inventors: Yoshihito KONDOH, Chuo-ku (JP); Masato MUROHASHI, Tokyo (JP)

(21) Appl. No.: 17/008,260

(22) Filed: Aug. 31, 2020

(30) Foreign Application Priority Data
Jul. 29, 2020 (JP) 2020-128305

(51) Int. Cl. A63F 13/61; A63F 13/525; G02B 27/01; A63F 13/56

(52) U.S. Cl. CPC A63F 13/61; A63F 13/56; G02B 27/017; A63F 13/525

(57) ABSTRACT

To enable you to take animations in a virtual space, an animation production system for producing an animation for advertising video, the system comprising: a virtual camera that shoots a character placed in a virtual space; a user input detection unit that detects an input of a user from at least one of a head mounted display and a controller which the user mounted; a character control unit that controls an action of the character in response to the input; an image data storage unit that records action data including the action of the character captured by the camera; and an image producing unit that generates the advertising video while replacing an object in the virtual space according to a viewer based on the action data.

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

No attempt was made to capture animations in the virtual space.

The present invention has been made in view of such a background, and is intended to provide a technology capable of capturing animations in a virtual space.

### Solution to Problem

The principal invention for solving the above-described problem is a system for producing an animation for an advertisement video, comprising: a virtual camera for taking a character disposed in a virtual space; a user input detecting unit for detecting an input of the user from at least one of a head mount display and a controller mounted by a user; a character control unit for controlling the operation of the character in response to the input; an image data storage unit for recording action data including the operation of the character captured by the camera; and an image generating unit for generating the advertisement video while replacing an object in the virtual space in response to a viewer based on the action data.

The other problems disclosed in the present application and the method for solving them are clarified in the sections and drawings of the embodiments of the invention.

### ADVANTAGEOUS EFFECTS OF INVENTION

According to the present invention, animations can be captured in a virtual space.

### BRIEF DESCRIPTION OF DRAWINGS

FIG. 1 is a diagram illustrating an example of a virtual space displayed on a head mount display (HMD) mounted by a user in an animation production system 300 of the present embodiment.

FIG. 2 is a diagram illustrating an example of the overall configuration of an animation production system 300 according to an embodiment of the present invention.

FIG. 3 is a diagram schematically illustrating the appearance of the HMD 110 according to the present embodiment.

FIG. 4 is a diagram illustrating an example of a functional configuration of the HMD 110 according to the present embodiment;

FIG. 5 is a diagram schematically illustrating the appearance of the controller 210 according to the present embodiment.

FIG. 6 is a diagram illustrating an example of a functional configuration of a controller 210 according to the present embodiment;

FIG. 7 is a diagram illustrating a functional configuration of an image producing device 310 according to the present embodiment;

FIG. 8 is a diagram illustrating a flow of a distribution process of a movie by an animation production system according to the present embodiment;

### DESCRIPTION OF EMBODIMENTS

The contents of embodiments of the present invention will be described with reference. The present invention includes, for example, the following configurations.

### Item 1

A animation production system for producing an animation for advertising video, the system comprising:

a virtual camera that shoots a character placed in a virtual space;

a user input detection unit that detects an input of a user from at least one of a head mounted display and a controller which the user mounted;

a character control unit that controls an action of the character in response to the input;

an image data storage unit that records action data including the action of the character captured by the camera; and

an image producing unit that generates the advertising video while replacing an object in the virtual space according to a viewer based on the action data.

### Item 2

The animation production system according to claim 1, wherein the image producing unit changes the character in accordance with the viewer.

### Item 3

The animation production system according to claim 1, wherein

the image producing unit changes the model data of the character in accordance with the viewer.

### Item 4

The animation production system according to claim 1, wherein

the image producing unit changes an object other than the character disposed in the virtual space according to the viewer.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### Overview

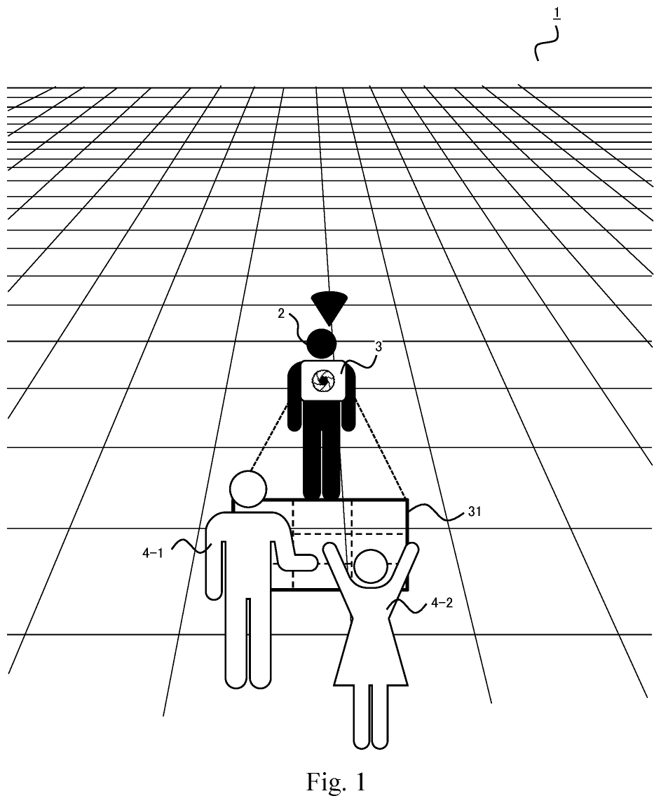

FIG. 1 is a diagram illustrating an example of a virtual space displayed on a head mount display (HMD) mounted by a user in an animation production system 300 according to the present embodiment. In the animation production system 300 of the present embodiment, a virtual character 4 and a virtual camera 3 are disposed in the virtual space 1, and a character 4 is shot using the camera 3. In the virtual space 1, a photographer 2 (a photographer character) is disposed, and the camera 3 is virtually operated by the photographer 2. In the animation production system 300 of this embodiment, as shown in FIG. 1, the user arranges the character 4 and the camera 3 while viewing the virtual space 1 from a bird's eye (Third Person's View), shoots the character 4 using the FPV (First Person View) as the photographer 2, and performs the performance of the character 4 using the FPV, while producing the animation. In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e.g., characters 4-1 and 4-2). That is, in the animation production system 300 of the present embodiment, one can play a number of roles (roles). In addition, since the camera 2 can be virtually operated as the photographer 2, natural camera work can be realized and the representation of the movie to be shot can be enriched.

### General Configuration

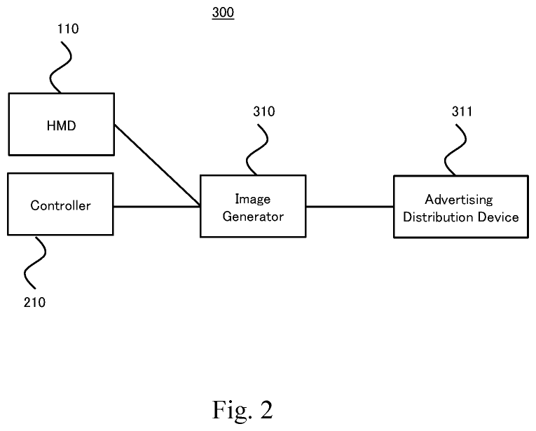

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the s animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth (™), WiFi (™). The image generating device 310 may be a PC, a game machine, a portable communication terminal, or any other device having a calculation processing function. The image producing device 310 is communicatively connected with the advertising distribution device 311. The advertising distribution device 311 may be, for example, a server providing an advertisement with content, such as a web page including an advertisement space, or may be an advertising distribution server providing an advertisement to a web page, an app, or the like. In this embodiment, it is assumed that the video image generated by the image producing device 310 is provided to the advertising distribution device 311 as a video advertisement.

### HMD110

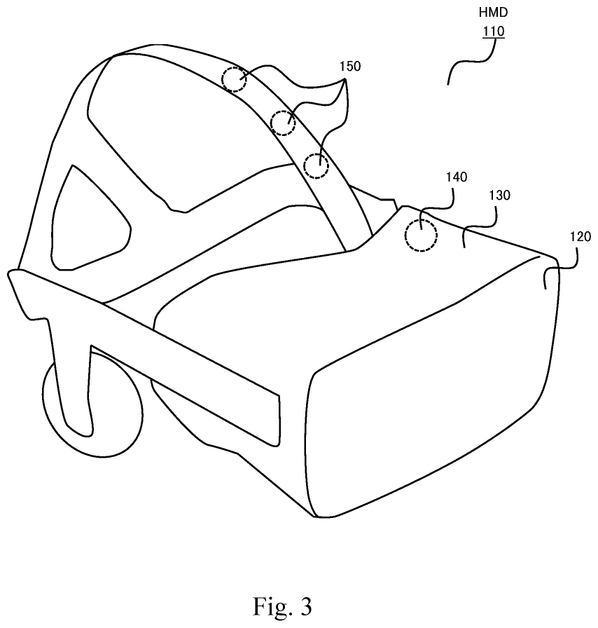

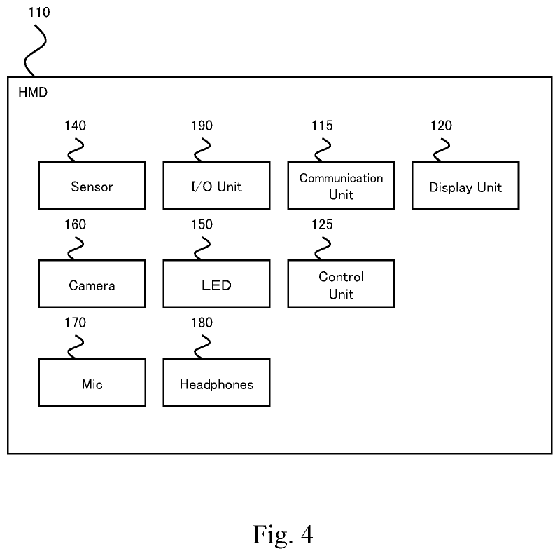

FIG. 3 is a diagram schematically illustrating the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although the display panel 120 may be an optically transmissive or non-transmissive display, the present embodiment illustrates a non-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e.g., infrared light LEDs, visible light LEDs). A camera (e.g., an infrared light camera, a visible light camera) installed outside the HMD 110 (e.g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### Controller 210

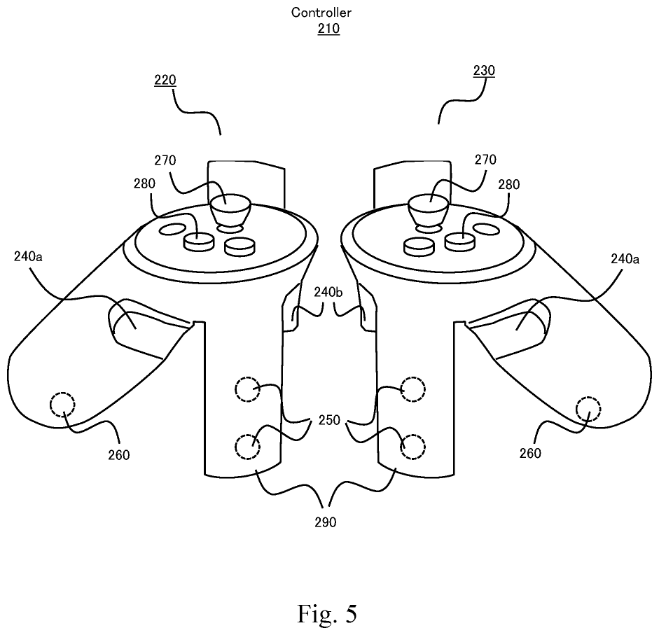

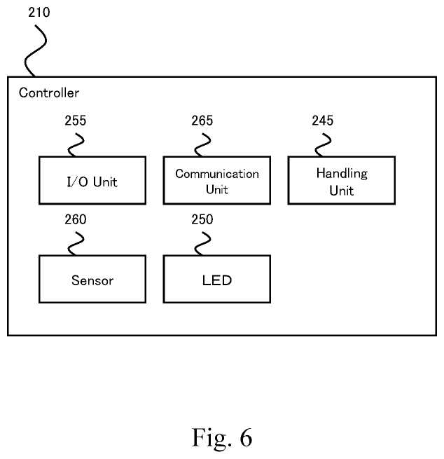

FIG. 5 is a diagram schematically illustrating the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### Image Generator 310

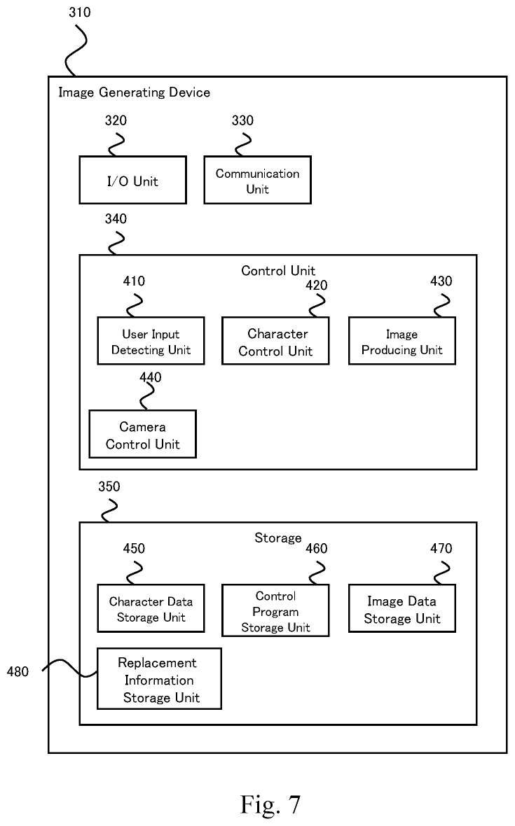

FIG. 7 is a diagram illustrating a functional configuration of an image producing device 310 according to the present embodiment. The image producing device 310 may use a device such as a PC, a game machine, or a portable communication terminal, which has a function for storing information on the movement of the user's head or the movement or operation of the controller acquired by the user input information or the sensor, which is transmitted from the HMD 110 or the controller 210, performing a predetermined computing process, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). Information received from the HMD 110 and/or the controller 210 through the I/O unit 320 and/or the communication unit 330 regarding the movement of the user's head or the movement or operation of the controller 210 is detected in the control unit 340 as input content including the operation of the user's position, line of sight, attitude, etc., speech, operation, etc., and a control program stored in the storage unit 350 is executed according to the user's input content to perform a process such as controlling the character 4 and generating an image. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding the movement of the user's head, the user's speech, and the movement or operation of the controller; a character control unit 420 that executes a control program stored in the control program storage unit 460 for a character 4 stored in the character data storage unit 450 of the storage unit 350; a camera control unit 440 that controls a virtual camera 3 disposed in the virtual space 1 in accordance with the character control; and an image producing unit 430 that generates an image in which the camera 3 captures the virtual space 1 based on the character control. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings for the camera 3 (for example, the position within the virtual space 1 of the camera 3, the viewing direction of the camera 3, the focus position, the zoom, etc.) depending on the movement of the hand of the character 4. The image producing unit 430 registers the action data representing the movement of the character 4 controlled by the character control unit 420 and the movement (operation) of the camera 3 controlled by the camera control unit 440 in the image data storage unit 470, and generates an image in which the movement of the character 4 is virtually captured by the camera 3.

The storage unit 350 stores in the aforementioned character data storage unit 450 information related to the character 4, such as the attribute of the character 4, as well as the image data of the character 4. A texture image attached to the surface of the character 4 is also stored in the character data storage unit 450. The character data storage unit 450 may also store deformation data for deforming the skeleton of the character 4. The character data storage unit 450 may also store several versions of model data corresponding to the same character. For example, the same character can store model data for different skin and bone races. The character data storage unit 450 may also store model data for various objects (e.g., desks, chairs, cups, beverages, etc.) disposed in the virtual space 1 in addition to the character 4. The control program storage unit 460 controls the operation and expression of the character 4 in the virtual space and stores a program for controlling an object such as the camera 3. The image data storage unit 470 stores the image generated by the image producing unit 430. In this embodiment, the image stored in the image data storage unit 470 can be an action data for generating a moving image. The action data may include, for example, 3D data for displaying the character 4 in the virtual space 1, pause data for identifying the bone structure of the 3D data, motion data for identifying the movement of the bone structure, and the like. In addition, the image producing unit 430 may create (render) a moving image based on the action data and register the video data as a result of rendering in the image data storage unit 470. The replacement information storage unit 480 stores information (replacement information) for replacing a portion of the action data stored in the image data storage unit 470. The replacement information storage unit 480 may store replacement information corresponding to the advertising target. The target of the advertisement is information identifying the viewer and may be information indicating the segment of the viewer. The segment of the viewer may be a variety of segments to be targeted for advertising (e.g., the viewer's demographic attribute, geographic attribute, psychographic attribute and behavioral attribute, as well as conditions for interest such as being a fan of a particular character). The replacement information may include, for example, the original object and the object to be replaced, corresponding to the viewer information representing the viewer (such as the viewer's attributes or interests).

When generating an image to be transmitted to the advertising distribution device 311, the image producing unit 430 acquires information indicating the viewer, reads out the replacement information corresponding to the acquired viewer, renders the model data included in the action data while replacing the model data based on the read replacement information, and transmits the rendered video image as an advertising video to the advertising distribution device 311. For example, the image producing unit 430 may acquire the viewer information related to the viewer who is viewing the content provided by the advertising distribution device 311 that is a web server by a publicly known method. The image producing unit 430 may receive the designation of the viewer information from the user of the image producing device 310.

The replacement information may include, for example, information corresponding to information indicating a viewer as a fan of a particular character, information representing a character 4 in the virtual space 1 as a replacement source, and information representing model data of the particular character as a replacement destination. Accordingly, when rendering based on the action data, the image producing unit 430 can perform rendering by replacing the main character 4 with the model data of the character in which the viewer is a fan for a particular viewer.

In addition, the replacement information may include, for example, information corresponding to information representing a specific country, information representing a character 4 in the virtual space 1 as a replacement source, and information representing a model data of a race corresponding to the country as a replacement destination. Accordingly, when rendering based on the action data, the image producing unit 430 may render the main character 4 to a viewer residing in a specific country by replacing the main character 4 with model data of race representative to the country in which the viewer resides.

The replacement information may also include information corresponding to the information indicating the viewer, identifying the object of the beverage disposed in the virtual space 1 as a replacement source, and information representing model data representing the object of a particular product targeted at the viewer as a replacement destination. This allows replacement advertisements to replace objects to be placed according to the viewer with advertising products.

### Send Movie

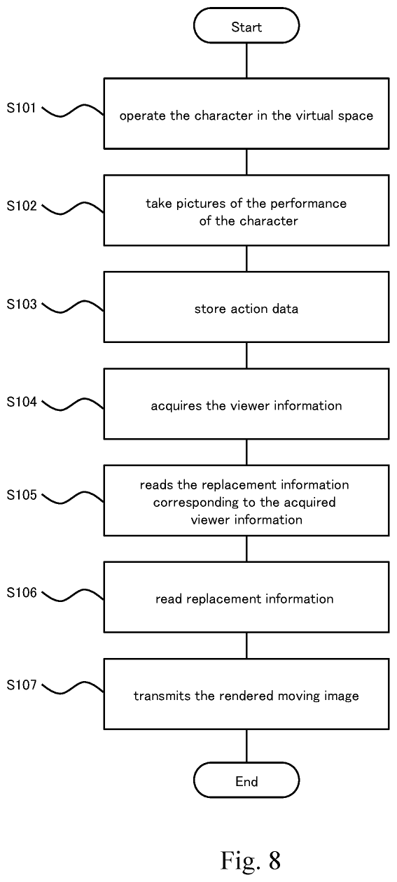

FIG. 8 is a diagram illustrating a flow of a distribution process of a movie by an animation production system according to the present embodiment.

The user can operate the character 4 in the virtual space 1 by operating the HMD 110 or the controller 210 (S101), and the camera 3 can be controlled by operating the camera 2 to take pictures of the performance of the character 4 (S102). The performance of the character 4 and the photographing of the camera 3 may be performed simultaneously, or the performance of the character 4 may be performed first, the action data may be recorded, and the action data may be reproduced before being shot with the camera 3. The operation of the character 4 (and all objects in the virtual space 1) shot by the camera 3 is stored as action data (S103).

The image producing unit 430 acquires the viewer information identifying the viewer to be distributed with the movie (S104), reads the replacement information corresponding to the acquired viewer information (S105), makes rendering while replacing the object included in the action data based on the read replacement information (S106), and transmits the rendered moving image to the advertising distribution device 311 (S107).

As described above, according to the animation production system 300 of the present exemplary embodiment, a user can operate the camera 3 as the camera man 2 in the virtual space 1 to take video images. Accordingly, since the camera 3 can be operated in the same way as in the real world to take photographs, it is possible to realize a natural camera work and to provide a richer representation of the animated video.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

In the present embodiment, the image producing device 310 transmits a moving image to the advertising distribution device 311. However, the image producing device 310 can also be an advertising distribution system having an advertising distribution unit in which the image producing device 310 itself conducts an advertisement distribution.

In addition, when replacing an object in the virtual space based on the replacement information, the operation of the object (character 4) may be corrected. For example, when the image producing unit 430 replaces a character having a different height or body size, the operation speed, angle, and the travel distance can be corrected according to the length of the bone such as the arm or the leg. In addition, the image producing unit 430 sets the movement range for each character 4 and can perform correction so that the image producing unit 430 operates only within the movable range. This may, for example, represent a difference in representation between a hard character of the body and a soft character of the body.

### EXPLANATION OF SYMBOLS

1 virtual space

2 cameraman

3 cameras

4 characters

6 control panel

7 Screens

31 Grid

32 split line

61 display

71 display

72 playback button

110 HMD

120 display panel

130 housing

140 sensor

150 light source

210 controller

220 left hand controller

230 right hand controller

235 grip

240 trigger button

250 Infrared LED

260 sensor

270 joystick

280 menu button

300 Animation Production System

310 Image Generator

311 Advertising Distributor

320 I/O portion

330 communication section

340 controller

350 storage

410 User Input Detector

420 character control unit

430 Image Generator

440 Camera Control

450 character data storage section

460 Control Program Storage

470 Image Data Storage

480 Replacement Information Storage

1. A animation production system for producing an animation for advertising video, the system comprising:
a virtual camera that shoots a character placed in a virtual space;
a user input detection unit that detects an input of a user from at least one of a head mounted display and a controller which the user mounted;
a character control unit that controls an action of the character in response to the input;
an image data storage unit that records action data including the action of the character captured by the camera; and
an image producing unit that generates the advertising video while replacing an object in the virtual space according to a viewer based on the action data.

2. The animation production system according to claim 1, wherein
the image producing unit changes the character in accordance with the viewer.

3. The animation production system according to claim 1, wherein
the image producing unit changes the model data of the character in accordance with the viewer.

4. The animation production system according to claim 1, wherein
the image producing unit changes an object other than the character disposed in the virtual space according to the viewer.
